(19) United States
(12) Patent Application Publication
(10) Pub. No.: US 2026/0368746 A1
(43) Pub. Date: Nov. 19, 2026

(54) PRODUCT RECALL ASSESSMENT

(71) Applicant: Honeywell International Inc., Charlotte, NC (US)

(72) Inventors: Waad Subber, Schenectady, NY (US); Vaibhav Bhaskar Deo, Pune (IN); Ankit Singh, Apex, NC (US)

(21) Appl. No.: 19/209,805

(22) Filed: May 16, 2025

(51) Int. Cl. G06Q 30/014

(52) U.S. Cl. CPC G06Q 30/014

(57) ABSTRACT

Approaches for automated product recall management are described. The approach includes obtaining product quality event data for each of a plurality of products manufactured by an organization. The product quality event data is then analyzed to obtain a recurring value of each quality event of the one or more quality events for each product of the plurality of products. For each product of the plurality of products, a cumulative recurring value is determined based on the recurring value of each of the one or more quality events associated to the product. One or more anomalous products amongst from the plurality of products are determined upon ascertaining deviation of the cumulative recurring value with a range of pre-determined threshold values. A comprehensive analysis report based on the one or more anomalous products is generated for product recall management. Thus, the described approaches facilitate quick decision-making on potential product recalls and improving overall quality management in manufacturing processes.

### BACKGROUND

A variety of products, including mobile phones, automobiles, electronics, pharmaceutical products, and everyday items, are often produced in large quantities. When a product includes a defect or is unsafe for use, it can lead to serious consequences such as harm to user's health, loss of customer's trust, and legal issues. To address these problems, an organisation associated with the product can implement rigorous quality control measures, respond promptly to customer complaints, and conduct regular inspections. One effective way to deal with significant defects or safety issues is to recall the affected products. This helps prevent further distribution of hazardous products and protects consumers, while also maintaining the organisation's reputation and avoiding regulatory penalties. For example, mobile phones manufactured in a specific region, might be recalled if defects are discovered in some models of the mobile phones in the specific region. The proactive approach of recalling not only helps in maintaining consumer trust and safeguarding the company's reputation but also minimizes the risk of facing regulatory fines or legal consequences. Therefore, it is crucial for an organisation to thoroughly investigate and make informed decisions regarding the recall of mobile phones, considering the geographical distribution of the products.

### BRIEF DESCRIPTION OF FIGURES

Systems and/or methods are now described, in accordance with examples of the present subject matter and with reference to the accompanying figures, in which:

FIG. 1 illustrates a system for product recall management, according to an example;

FIG. 2 illustrates a computing environment implementing the system for product recall management associated with a plurality of products manufactured by an organization, according to an example;

FIG. 3 illustrates a flow diagram depicting an exemplary sequence for product recall management associated with a plurality of products manufactured by an organization, according to an example;

FIG. 4 illustrates aggregating operators for aggregating product quality event data, according to an example;

FIG. 5 illustrates a method for product recall management, according to an example;

FIG. 6 illustrates a method for analyzing the product quality event data, according to an example;

FIG. 7 illustrates a method for determining the one or more anomalous products amongst the plurality of products, according to an example, and

FIG. 8 illustrates a computing environment implementing a non-transitory computer-readable medium for product recall management, according to an example.

### DETAILED DESCRIPTION

Increasing demand for products in today's fast-paced marketplace has made product recall management an essential aspect of business operations. As manufacturers strive to innovate and enhance their products, the complexity of products and their associated technologies has grown. This evolution, while beneficial, has also heightened the potential for safety issues to arise. Consequently, across all sectors, ensuring product safety and quality has transitioned from being merely a regulatory obligation to a fundamental responsibility that manufacturers must uphold. As safety concerns become more prevalent, the necessity for effective recall management has emerged. Organisations can no longer afford to overlook the implications of a product recall, as failures in this area can lead to severe repercussions, including damage to brand reputation, financial losses, and even legal liabilities.

In general, recall management refers to the systematic process of retrieving and addressing products that have been identified as unsafe or defective after reaching consumers. When a product is found to pose a risk, whether due to health hazards, defects, or potential legal liabilities, a recall becomes essential. The repercussions of product recalls can be extensive. For consumers, recalls often lead to inconvenience and dissatisfaction, while manufacturers face significant financial burdens. The costs associated with retrieving and replacing defective products can be substantial, but the loss of consumer trust can have a more profound impact on long-term brand loyalty. Furthermore, large-scale recalls disrupt not only the manufacturers' operations but also ripple through the entire supply chain, affecting retailers and distributors alike. On the other hand, failing to address safety concerns can jeopardize consumer well-being and lead to severe reputational damage, hefty fines, or legal consequences for the organisation involved.

The recall process generally involves several key steps, including identifying the affected products, assessing the risk, notifying consumers and relevant authorities, and implementing measures to retrieve or correct the unsafe items. Effective recall management not only prioritizes consumer safety but also aims to protect the organisation's reputation and mitigate financial losses.

Conventionally, organizations may utilize systems to analyze products related data on an ongoing basis. These systems are manually operated by administrators employed by the organisation. These administrators may configure the system to detect patterns or trends that could potentially signal the need for further investigation or recall actions on one or more products. The automated analysis may involve setting predefined thresholds for various types of quality events related to specific products. When the system detects that these thresholds have been reached or surpassed, it may generate alerts to notify relevant personnel that additional scrutiny or potential recall procedures may be warranted. In an example, the thresholds for initiating product investigations may be established in advance based on various factors such as industry standards, organizational requirements, and expert knowledge. While predefined thresholds can play a role in maintaining product safety and quality, relying solely on static thresholds may present certain limitations, since the effectiveness of this approach may depend on the availability of relevant expertise and the consistency of decision-making processes. In cases where expert knowledge is limited or decision-making quality varies, the resulting thresholds may not always accurately reflect evolving product quality dynamics. This variability could potentially impact the reliability of the threshold-based system and its ability to identify quality issues in a timely manner. Due to high dependency of the conventional approaches on human resources and existence of various phases of investigations involving manual effort, the process of making a recall decision becomes a time consuming and a tedious task, leading to unnecessary delays in making the recall decision. Delay in making the recall decision may turn out to be highly disadvantageous for the organization as such a delay may increase regulatory penalties, customer compensations, legal liabilities, and damage control costs. Further, risks of human errors while making the recall decision are also typically high. Such human errors may either lead to recalling of product batches which were not required to be recalled, or non-recalling of product batches which were actually required to be recalled. Errors in the recall decision may jeopardize lives of the consumers of the products and may lead to unnecessary monetary losses for the organization. The problems associated with the delay and the errors in the recall decision may further escalate as the number of products and product batches belonging to the organization increases.

The present subject matter describes approaches to enhance the process of identifying products or batches of products that may require investigation or potential recall. In the approach, an artificial intelligence (Al) based framework may be utilized to analyze product quality event data which may be information collected and recorded during instances where a product's quality is found to be compromised. The system may utilize self-tuning models that can adapt their parameters based on the product quality events data, potentially reducing the need for frequent manual adjustments.

In an example, product quality event data for each of a plurality of products manufactured by an organization is obtained. The product quality event data may include one or more quality events indicative of quality incident for each product of the plurality of products. In an example, the one or more quality events may be complaints, deviations, non-conformances, and Corrective and Preventive Actions (CAPA) associated to each of the plurality of products. For example, number of complaints within a specific timeframe (weekly, monthly, or yearly), the number of critical deviations, particularly those with high severity, the geographical distribution and impact of reported issues associated to the plurality of products are obtained.

In an example, the product quality event data is processed. For example, complaint severity (e.g., low, medium, high) is converted into quantifiable scores. In another example, the product quality event data is processed in a standardized, structured format, making it suitable for further analysis to clean and preprocess the descriptions of quality events, such as complaint descriptions. This may involve extracting key words from the description that indicates severity of complaint. In an example, semantic and syntactic characteristics corresponding to each of the plurality of products by processing the product quality event data using a text cleansing model. In an example, the text cleansing model is a natural language processing (NLP) model for cleaning and preprocessing the product quality event data, making it suitable for analysis.

Subsequently, the product quality event data is analyzed using a recurrent event model to obtain a recurring value of each quality event of the one or more quality events for each product of the plurality of products. For example, a recurring value of a product having a sudden increase in the number of complaints over a short period may be obtained. Similarly, a recurrent value of product having a significant spike in high-severity deviations from a specific region may be obtained. Further, for each product of the plurality of products, a cumulative recurring value is determined based on the recurring value of each of the one or more quality events associated to the product. The cumulative recurring value may be indicative of all quality incidents associated with the product. In an example, the cumulative recurring value may be a recurrent complaint count indicating a similar complaint reported within a prespecified time.

In an example, one or more anomalous products amongst from the plurality of products are determined on ascertaining deviation of the cumulative recurring value with a range of pre-determined threshold values. In an example, unsupervised machine learning technique, such as, clustering is used to determine the one or more anomalous products. In an example, using the clustering technique one or more anomalous products amongst the plurality of products are determined that deviate from the norm based on pattern that differs from the majority of the products amongst the plurality of products. For example, one or more products having a high complaint severity within a week are determined as the one or more anomalous products.

Once the one or more anomalous products are determined, a Large Language Model (LLM) may be used to automatically generate a comprehensive analysis report. The comprehensive analysis report may be based on the one or more anomalous products for product recall management. In an example, the report serves to summarize the findings, provide insights into why certain batches were flagged, and present actionable information for decision-makers. The comprehensive analysis report may include recommendations for taking corrective actions for the one or more anomalous products.

In the present subject matter, by leveraging machine learning techniques, the system may be capable of recognizing evolving patterns and adjusting its criteria accordingly. This adaptive capability may allow the system to maintain its effectiveness over time as product characteristics and quality patterns change. The Al-driven approach may complement existing quality management processes, potentially providing additional insights to support decision-making regarding product investigations or recall considerations. The system may contribute to ongoing efforts to maintain product quality and respond efficiently to potential quality concerns.

The present subject matter offers significant advantages in proactive product assessment and management. By leveraging data available on diverse public forums and employing a dynamic, multi-step analytical process, potential safety concerns and quality issues may be identified at a quicker phase. The ability to analyze and integrate information from various public forums provides a comprehensive view of potential risks, allowing manufacturers to take pre-emptive actions and may potentially avoid large-scale recalls.

The present subject matter generates customized assessment reports that provide the manufacturers with actionable insights specific to their target product, facilitating informed decision-making and enabling timely implementation of strategies for mitigating the quality concerns. By offering a proactive and data-driven method for product management, the present subject matter enables the manufactures to maintain product quality, protect consumers from safety risks, and safeguard their reputation in the market. The sequential implementation of diverse analytical techniques allows for a nuanced and thorough examination of the quality event data. Ultimately, the present invention addresses a critical gap in current product quality assessment practices, potentially leading to significant cost savings and enhanced consumer trust.

The described approaches thus facilitate generation of a comprehensive analysis report providing essential information related to one or more anomalous products enabling a better recall management assessment, thereby helping the organizations to avoid reputational damage, regulatory penalties, legal repercussions, or jeopardizing the customer's lives that may occur due to the one or more anomalous products.

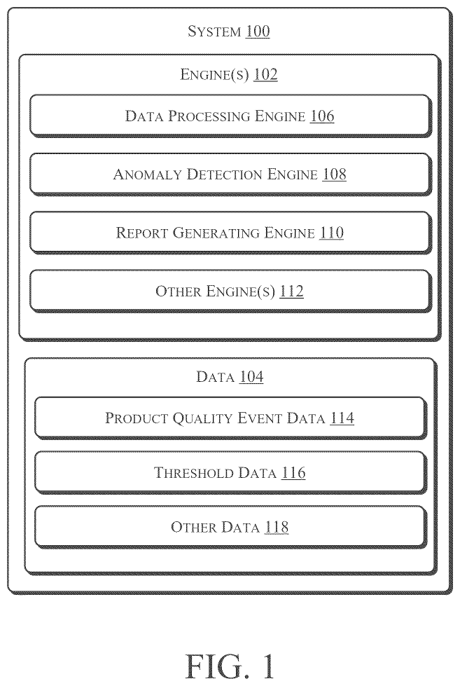

The present subject matter is further described with reference to FIG. 1 to FIG. 8. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for product recall management, according to an example. In one example, the system 100 may be a distributed computing system having one or more physical computing systems geographically distributed at same or different locations. In another example, one or more components of the system 100 may be hosted virtually, for example, on a cloud-based platform, while other components may be geographically distributed at same or different locations. In yet another example, the system 100 may be a stand-alone physical system geographically located at a particular location. In an example, the system 100 may be utilized by organizations that aim to assess quality risk associated with their respective products or batches or products.

In one example, the system 100 may include engine(s) 102 and data 104. The system 100 may also include additional components, such as display, input/output interfaces, operating systems, applications, and other software or hardware components (not shown in the figures).

The engine(s) 102 may be implemented as a combination of hardware and programming, for example, programmable instructions to implement a variety of functionalities of the engine(s) 102. In examples described herein, such combinations of hardware and programming may be implemented in several different ways. For example, the programming for the engine(s) 102 may be executable instructions. Such instructions may be stored on a non-transitory machine-readable storage medium which may be coupled either directly with the system 100 or indirectly (for example, through networked means). In an example, the engine(s) 102 may include a processing resource, for example, either a single processor or a combination of multiple processors, to execute such instructions. In the present examples, the non-transitory machine-readable storage medium may store instructions that, when executed by the processing resource, implement the engine(s) 102. In other examples, the engine(s) 102 may be implemented as electronic circuitry.

In one example, the engine(s) 102 may include a data processing engine 106, an anomaly detection engine 108, a report generation engine 110, and other engine(s) 112. The other engine(s) 112 may further implement functionalities that supplement functions performed by the system 100 or any of the engine(s) 102.

The data 104 includes data that is either received, stored, or generated as a result of functions implemented by any of the engine(s) 102 or the system 100. It may be further noted that information stored and available in the data 104 may be utilized by the engine(s) 102 for performing various functions of the system 100. The data 104 may include product quality event data 114, threshold data 116, and other data 118. The product quality event data 114 may include data related to products manufactured by an organization hosting the system 100. The threshold data 118 may include data related to threshold values determined by the system 100. The other data 118 may include data that is either received, stored, or generated as a result of functions implemented by any of the engine(s) 102.

In operation, the data processing engine 106 may obtain the product quality event data corresponding to each of a plurality of products manufactured by the organization. In an example, the product quality event data may be obtained from a quality management system implemented for managing and storing data related to quality concerns raised for products manufactured by the organization. In another example, the product quality event data may be pre-stored in a memory of the system 100 and may be obtained from the memory. The product quality event data may include one or more quality events indicative of quality incident for each product of the plurality of products. In an example, the one or more one or more quality events indicative of quality incident for each product of the plurality of products may include complaints, deviations, non-conformances, and Corrective and Preventive Actions (CAPA) associated to respective products within the plurality of products. In one example, the product data may be stored as the product quality event data 114.

Upon obtaining the product quality event data, the product quality event data is processed. In an example, the processing of the product quality event data may include mapping approaches to convert categorical variables into quantifiable variables for further processing and analysis. For example, upon obtaining complaint severity associated with a product, the system 100 may transform the complaint severity into numerical values using an encoding approach. In another example, the processing of the product quality event data may involve cleaning and preprocessing of the descriptions of quality events, such as complaint descriptions. For example, the system 100 may obtain keywords describing complaint severity such as, highly ineffective, not working, problematic product, etc. and remove the remaining words from the complaint descriptions. The keywords may then be transformed from categorical variables into quantifiable variables for further processing and analysis.

Subsequently, the product quality event data is analyzed using a recurrent event model to obtain a recurring value of each quality event of the one or more quality events for each product of the plurality of products. For example, the system 100 may obtain a recurring value of a product having a sudden increase in the number of complaints over a short period. The recurring value of the product may denote the number of the times a complaint for the particular product has reoccurred. In another example, the system 100 may obtain a recurring value of a product having a significant spike in high-severity deviations from a specific region. In an example, for each of the plurality of products, a cumulative recurring value is determined based on the recurring value of each of the one or more quality events associated to the product. The cumulative recurring value may be indicative of all quality incidents associated with the product. In an example, the cumulative recurring value may be a recurrent complaint count indicating a similar complaint reported within a prespecified time.

In an example, the product quality event data, the recurring value, and the cumulative recurring value associated with each of the plurality of products, may be aggregated for a specific time. For example, the recurring value and the cumulative recurring value associated with each of the plurality of products for 6 months for a specific geographical location. The large volumes of detailed information aggregated into more manageable and actionable metrics making it easier for informed decisions.

In an example, one or more anomalous products amongst the plurality of products are determined by the anomaly detection engine 108 of the system 100. In an example, for each of the one or more anomalous products, the anomaly detection engine 108 may ascertain deviation of the cumulative recurring value that are associated each of the one or more anomalous products, with a range of pre-determined threshold values. In an example, the threshold data 116 may include the range of pre-determined threshold values. In an example, the range of pre-determined threshold values may be provided by a user of the system 100 after initiating the system 100. In an example, the range of pre-determined threshold values may be stored with the memory of the system 100. In an example, the anomaly detection engine 108 may use unsupervised machine learning technique, such as, clustering to determine the one or more anomalous products. For example, the anomaly detection engine 108 may determine, using clustering, one or more products having a high complaint severity within a week. The one or more products thus deviate from the norm based on pattern that differs from the majority of the products amongst the plurality of products. Thus, the anomaly detection engine 108 may determine the one or more products as the anomalous products.

Subsequent to the determination of the one or more anomalous products, the report generating engine 110 may use a Large Language Model (LLM) to automatically generate a comprehensive analysis report. In an example, the comprehensive analysis report may be based on the one or more anomalous products for product recall management. In an example, the comprehensive analysis report serves to summarize the findings, provide insights into why certain product(s) were flagged, and present actionable information for decision-makers. In an example, the comprehensive analysis report may include a summary describing purpose of detecting one or more anomalous products and the importance of such detection in maintaining quality and compliance. In another example, the comprehensive analysis report may include explanation of the methods used in the analysis, including the machine learning algorithms and anomaly detection techniques applied. In an example, the comprehensive analysis report may include the other data 118, such as, description of the complaints, deviations and geographical distribution of the products. In an example, the comprehensive analysis report may provide insights into the severity of issues, geographical distribution, or any recurring patterns that might be influencing the anomalies among the one or more anomalous products. In an example, the comprehensive analysis report may include information explaining factors influencing the detection of the one or more anomalous products. In an example, the report generating engine 110 may include an explainability model, such as, SHapley Additive explanations (SHAP) to generate the comprehensive analysis report. In an example, the comprehensive analysis report may include information on the feature contributions, showing how different variables (e.g., severity of complaints, number of deviations) influenced the detection of the anomaly. In an example, the comprehensive analysis report may include recommendations for taking corrective actions for the one or more anomalous products.

In an example, the report generating engine 110 may receive suitable prompts from the user of the system 100, for generating customized comprehensive analysis report. In another example, the report generating engine 110 may automatically generate the comprehensive analysis report.

Thus, the described approaches generate an insightful report for the organization, enabling the organization to efficiently and quickly recall product(s) or take other corrective actions to minimize the monetary losses incurred by the organization due to the anomalous products.

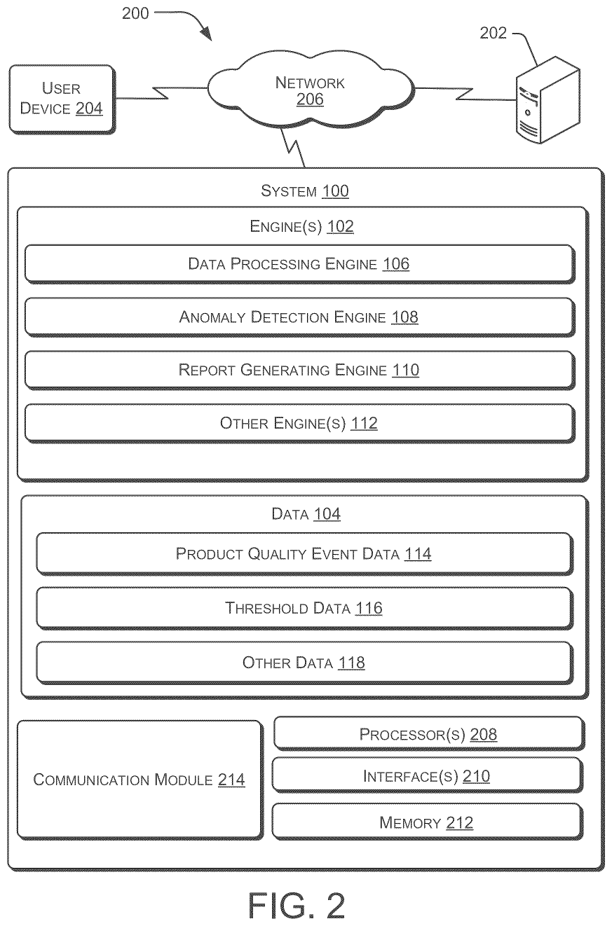

FIG. 2 illustrates a computing environment 200 implementing the system 100 for product recall management associated with a plurality of products, according to an example. In one example, the computing environment 200 may include the system 100, a data server 202, and a user device 204. The computing environment 200 may represent a networked architecture that enables communication and data exchange between various components for the purpose of product quality management and recall decision-making.

In an example, the data server 202 may be configured to implement a quality management system for an organization. The quality management system may enable the organization to manage and store product quality event data for products manufactured by the organization. The product quality event data may include description of quality concerns raised for the products manufactured by the organization. In one example, the data server 202 may be managed by the organization. In another example, the data server 202 may be managed by a third party entity providing quality management services to the organization. In an example, the data server 202 may be a distributed computing system having one or more physical computing systems geographically distributed at same or different locations. In another example, one or more components of the data server 202 may be hosted virtually, for example, on a cloud-based platform, while other components may be geographically distributed at same or different locations. In yet another example, the data server 202 may be a stand-alone physical system geographically located at a particular location.

In an example, the user device 204 may be a device over which the system 100 may be operated by a user, such as a quality manager of an organization. In an example, the user device 204 may be used by the user to monitor and manage the product(s), manufactured by the organization. Examples of the user device 204 may include, but are not limited to, a mobile phone, a laptop, a tablet, and a personal digital assistant (PDA). Although one user device 204 has been illustrated in FIG. 2 for the sake of brevity, it should be understood to a person skilled in the art that any number of user devices 204 may be connected with the system 100 to receive update about the quality of the product batches.

The system 100, the data server 202, and the user device 204 may be communicably coupled with each other over a communication network 206 and may exchange data and signals over the communication network 206. The communication network 206 may be a wireless network, a wired network, or a combination thereof. The communication network 206 may also be an individual network or a collection of many such individual networks, interconnected with each other and functioning as a single large network, e.g., the Internet or an intranet. Examples of such individual networks include local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN).

Depending on the technology, the communication network 206 may include various network entities, such as transceivers, gateways, and routers. In an example, the communication network 206 may include any communication network that uses any of the commonly used protocols, for example, Hypertext Transfer Protocol (HTTP), and Transmission Control Protocol/Internet Protocol (TCP/IP).

In one example, the system 100 may include processor(s) 208, interface(s) 210, memory 212, a communication module 214, the engine(s) 102, and the data 104. The system 100 may also include other components, such as display, input/output interfaces, operating systems, applications, and other software or hardware components (not shown in the figures).

The processor(s) 208 may be implemented as microprocessors, microcomputers, microcontrollers, digital signal processors, central processing units, state machines, logic circuitries, and/or other devices that manipulate signals based on operational instructions. The interface(s) 210 may allow the connection or coupling of the system 100 with one or more other devices, such as the data server 202 and the user device 204, through a wired (e.g., Local Area Network, i.e., LAN) connection or through a wireless connection (e.g., Bluetooth®, Wi-Fi). The interface(s) 210 may also enable intercommunication between different logical as well as hardware components of the system 100.

The memory 212 may be a computer-readable medium, examples of which include volatile memory (e.g., RAM), and/or non-volatile memory (e.g., Erasable Programmable read-only memory, i.e., EPROM, flash memory, etc.). The memory 212 may be an external memory or an internal memory, such as a flash drive, a compact disk drive, an external hard disk drive, or the like. The memory 212 may further include the data 104 and/or other data 118 which may either be received, utilized, or generated during the operation of the system 100.

The communication module 214 may be a wireless communication module. Examples of the communication module 214 may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication module 214 may also include one or more antennas to enable wireless transmission and reception of data and signals. The communication module 214 may allow the system 100 to transmit data and signals to one or more other devices, such as the data server 202 and the user device 204; and receive data and signals from the one or more other devices.

The engine(s) 102 may include the data processing engine 106, the anomaly detection engine 108, the report generating engine 110, and the other engine(s) 112.

In operation, whenever a quality concern or a feedback, hereinafter referred to as a quality event, is raised by a user against a product, a record of the quality event may be created and saved in the data server 202. Examples of the quality events may include, but are not limited to, a complaint received against a product, a deviation associated with a product, a corrective and preventive action (CAPA) taken for a product, and a non-conformance assessment of a product. In an example, the complaint may be received from a consumer of the product, a supplier of the product, a quality inspector, or a quality manager associated with the organization who may assess the quality of the product. In one example, quality manager associated with the organization may raise the complaint based on internal quality-related investigations. In an example, the deviation may refer to positive or negative effects of the product resulting from a divergence from expected or established standards. In an example, the CAPA may refer to any improvement made to an organisation's processes for quality assurance and to mitigate undesirable situations like product nonconformities. In an example, the non-conformance assessment may be done by the organization to check if a product of the organization fails to meet any specified requirements resulting in non-conformance. The non-conformance assessment may be initiated in view of manufacturer's internal quality-related investigations or upon receiving a customer's complaint or based on observation of regulatory bodies, such as the food and drug administration (FDA). Non-conformance may occur on the product, raw material used for manufacturing the product, and the manufacturing process followed by the organization to manufacture the product. Thus, any sort of non-conformance, such as not utilizing the management system correctly or not following standard operating procedures may lead to faulty products or defective products. For example, quality events may manifest in various forms across different industries, each requiring specific attention and management. For instance, in the consumer electronics sector, a quality event may arise when a user reports that a newly purchased smartphone overheats during normal use. This complaint may be recorded in the data server 202 and may trigger an investigation into the product's thermal management system or battery performance. In the pharmaceutical industry, a deviation may occur when a batch of pain relief medication is found to contain a higher concentration of the active ingredient than specified in the product standards. This deviation may be indicative of a divergence from expected or established standards and may potentially impact patient safety.

In some cases, CAPA may be implemented in response to quality events. For example, in the automotive industry, after receiving multiple complaints about a car model's faulty brake system, a manufacturer may implement additional quality control checks in the production line and revise the brake system design. This CAPA process may represent an improvement made to the organization's processes for quality assurance and to mitigate undesirable situations like product nonconformities.

In an example, non-conformance assessments may be conducted by organizations to check if their products meet specified requirements. In an example, during a routine inspection, a food manufacturer may discover that a batch of canned soup does not meet the required PH levels specified in their quality standards. This non-conformance may be recorded and may initiate further investigation or corrective actions.

Quality managers associated with organizations may raise complaints based on internal quality-related investigations. For instance, a quality manager at a clothing manufacturer may notice an unusually high rate of returned items due to fabric discoloration and may initiate an investigation into the dyeing process. This internal quality event may be recorded in the data server 202 and may lead to process improvements or supplier evaluations.

Regulatory bodies, such as the food and drug administration (FDA), may also identify quality events during their observations. In an example, the FDA may conduct an inspection of a pharmaceutical plant and identify issues with the company's documentation practices for batch production records. These observations may be recorded as quality events and may necessitate corrective actions by the organization.

Non-conformance may occur on the product, raw material used for manufacturing the product, and the manufacturing process followed by the organization to manufacture the product. For example, an electronics manufacturer may discover that a batch of circuit boards received from a supplier does not meet the required conductivity specifications. This raw material non-conformance may be recorded as a quality event and may impact the final product quality. In another example, an audit may reveal that employees at a food processing plant are not consistently following the required sanitation procedures between production runs. This manufacturing process non-conformance may be recorded as a quality event and may lead to potential food safety risks if not addressed promptly. Thus, any sort of non-conformance, such as not utilizing the management system correctly or not following standard operating procedures, may lead to faulty products or defective products. These diverse examples illustrate the complex nature of quality events that may be recorded in the data server 202.

The data server 202 may record the quality events associated with each of the plurality of products at a particular geographical location associated with the organisation. In an example, the data server 202 may record the quality events from various geographical locations with the organisation. In an example, the data server 202 may transmit these quality event records to the system 100, in response to a request for the product quality event data received from the system 100. The product quality event data 114 may include one or more quality events indicative of quality of each product of the plurality of products. In an example, the product quality event data may correspond to a particular period of time. For example, the quality event may correspond to a period of past one month or a period of past six months. In an example, the data server 202 may record quality events for a multinational automotive manufacturer with production facilities in various countries. For instance, the data server 202 may record a series of customer complaints about excessive engine noise from vehicles produced at the organization's plant in location A. Simultaneously, it may log quality control reports indicating inconsistent paint finishes on vehicles manufactured at the company's facility in Location B. In another example, the data server 202 may store information about a corrective action implemented at the organization's assembly line in location C to address a recurring issue with faulty airbag deployments. These quality events from different geographical locations may be consolidated in the data server 202, providing a comprehensive view of the organization's global quality landscape.

In response to a request from the system 100, the data server 202 may transmit quality event records covering multiple products across various regions. For instance, the product quality event data 114 may include customer feedback on the comfort of seats in luxury sedans produced in location A, warranty claims related to transmission failures in vehicles assembled in the location A, and internal quality control reports on brake pad durability from the company's testing facility in location B. In an example, this product quality event data may correspond to the past six months, allowing the system 100 to analyze recent trends and patterns in product quality across the organization's operations. Alternatively, the data server 202 may provide quality event data for the past month, focusing on more immediate issues such as a sudden increase in reported infotainment system malfunctions across vehicles produced in multiple locations.

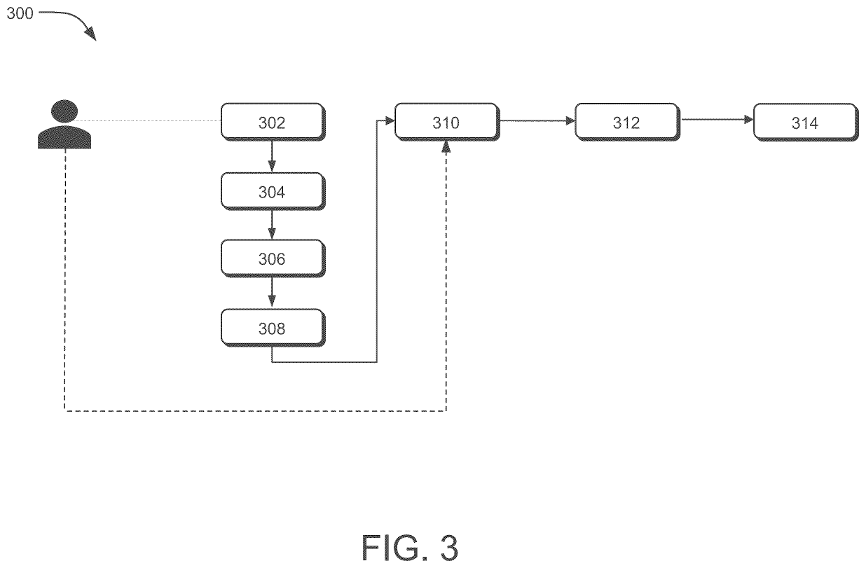

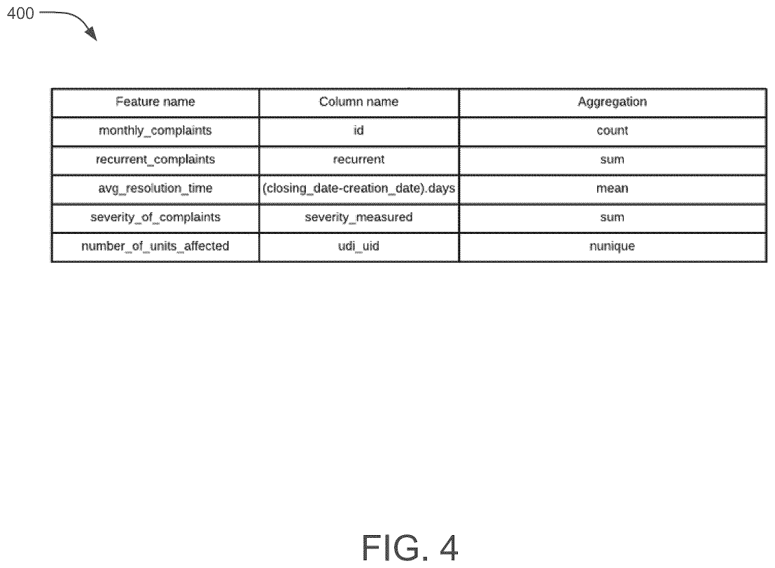

The communication module 214 of the system 100 may receive, from the data server 202, product data corresponding to each of a plurality of products manufactured by the organization. The system 100 may utilize the product quality event data to identify one or more anomalous products among the plurality of the products. The process followed by the system 100 for identifying one or more anomalous products for product recall management, is further described with the help of FIG. 3 and FIG. 4.

FIG. 3 illustrates a flow diagram 300 depicting an exemplary sequence for product recall management associated with a plurality of products manufactured by an organization, according to an example. The product recall management is executed by the system 100. In an example, at block 302, upon initiating the system 100 by a user, product quality event data for a plurality of products manufactured by an organization is obtained by the system 100. The product quality event data may include one or more quality events indicative of the quality of each product of the plurality of products. At bock 304, the system 100 may process the product quality event data. The system 100 may preprocess the descriptions of quality events, such as complaint descriptions. For example, a customer may submit a complaint against a product that “the product is of poor quality”, the system 100 may process this description to obtain semantic and syntactic characteristics corresponding to the product using a text cleansing model. In an example, the text cleansing model is a natural language processing (NLP) model for cleaning and preprocessing the product quality event data, making it suitable for analysis. The system 100 may obtain the keyword “poor quality” from the description indicative of the severity of complaint for the product. In an example, the text cleansing model may transform the complaint description into usable information by removing punctuation and special characters, numbers, extra spaces, emojis and emoticons. In another example, the text cleansing model may expand contractions (e.g., “don't” to “do not”) for clarity, removes common words (like “and”, “the”) that don't add significant meaning, may reduce reduces words to their base or root form, and may splits text into individual words or tokens. Thus, the product quality event data is processed in a standardized, structured format, making it suitable for further analysis to clean and preprocess the descriptions of quality events.

At block 306, the system 100 may convert the complaint severity (e.g., poor) into a quantifiable score. In an example, the system 100 may involve label encoding, binary encoding. In an example, the system 100 may involve vector embedding model (like BERT, Word2Vec, or GloVe) to convert the complaint text into vector embeddings. These embeddings capture the semantic meaning of the text. In an example, the system 100 may obtain one or more high-dimensional vectors representing semantic and syntactic characteristics of the product quality event data. In an example, the system 100 may parsing the one or more high-dimensional vectors through a vector space for searching vector embeddings in the vector space close to the high-dimensional vector.

At block 308, the product quality event data is analyzed using a recurrent event model to obtain a recurring value of each quality event of the one or more quality events for each product of the plurality of products. For example, a recurring value of a product having a sudden increase in the number of complaints over a short period may be obtained. Further, for each product of the plurality of products, a cumulative recurring value is determined based on the recurring value of each of the one or more quality events associated to the product. The cumulative recurring value may be indicative of all quality incidents associated with the product. In an example, the cumulative recurring value may be a recurrent complaint count indicating a similar complaint reported within a prespecified time. In another example, the cumulative recurring value may be recurrent complaint ratio indicating the ratio of recurrent complaints relative to total complaints for a given product or a group of products. In another example, the cumulative recurring value may include a time-series feature (e.g., a recurrent complaint pattern) tracking the trend of recurrent complaints over time. For example, an increasing time-series trend of recurrent complaints over time. Thus, if multiple customers repeatedly complain about the same issue, such as poor quality of the product, these complaints can be quantified and analyzed to understand the frequency and severity of the problem.

At block 310, the system 100 may aggregate the analyzed product quality event data for specified time (e.g., week, month, quarter, or year). In an example, the system 100 may use statistical functions for aggregating the analyzed product quality event data. The statistical functions may also be referred to as aggregating operator and may include summing function, mean function, count function, median function, min/max function etc. The summing function may total the numerical values across a group. For example, summing the number of complaints received for each product over a month. The mean function may calculate the average value within a group. For example, the average complaint severity score for a particular group of products. The count function may count the number of occurrences within each group, such as the number of non-conformance events within a specific time period. The min/max function may identify the minimum or maximum values within a group, such as the highest number of deviations reported in a week. The median function may find a middle value of a dataset, which is useful when the data distribution is skewed. In an example, the aggregation may take place at multiple levels or dimensions. For example, aggregating the product quality events data by region to compare complaint volumes across different areas. In another example, aggregating at both the weekly and monthly levels to compare short-term versus long-term trends. In another example, the aggregation can be customized according to a user input as shown in FIG. 4.

FIG. 4 illustrates aggregating operators, for block 310 of FIG. 3, for aggregating product quality event data, according to an example. In an example, the system 100 may include a list 400 of feature name associated to the plurality of products, the feature name may indicate a quality event associated with the product (e.g., monthly complaints, recurrent complaints, severity of complaints, etc). Further, the list 400 may include a column in which values associated with each feature name in the list is shown. In an example, these values may be provided by the user. In another example, the values associated with each of the feature names in the list 400 can be obtained by using aggregation operators including statistical functions, such as, summing function, mean function, count function, etc.

Further, the system 100 may include a list of the aggregating operators that the user may select. In an example, the system 100 may processes the list 400 of the feature name, column name, and the chosen aggregating operator, allowing for flexible aggregation based on the user requirements. For example, the feature name may include monthly complaints, recurrent complaints, severity of complaints, average resolution time, number of units affected etc. The column name corresponding to the feature name may include id, recurrent value, number of days counted for resolving the issue, severity measured respectively.

Returning back to FIG. 3, at block 312, one or more anomalous products amongst from the plurality of products are determined on ascertaining deviation of the cumulative recurring value with a range of pre-determined threshold values. In an example, the pre-determined threshold values may be stored in the system's memory. In another example, the pre-determined threshold values may be obtained by a server. The system 100 may apply unsupervised machine learning technique, such as, clustering to determine the one or more anomalous products. In an example, the clustering approach may be a density-based clustering approach. The system 100 may determine one or more anomalous products amongst the plurality of products that deviate from the norm based on pattern that differs from the majority of the products amongst the plurality of products. For example, when the clustering approach is applied on the analyzed product quality event data, clusters may form based on the similarity within the data. Each of the cluster may have a centroid. Data points that may be located far from the centroids of their assigned clusters can be flagged as potential anomalies. These data points may represent batches with characteristics that deviate significantly from the norm. In an example, batches that fall into very small clusters may indicate unique or rare patterns of behavior that are unusual compared to the majority of data points. These small clusters may be investigated further as potential anomalies. Further, batches that are marked as noise or located in sparse regions of the data space are classified as anomalies. In an example, the approach may be fine-tuned specifically for each product. In an example, a list of one or more anomalous products that exhibit unusual or unexpected behavior is generated. The one or more anomalous products are flagged as candidates for further investigation, as they may indicate potential issues or deviations from expected quality standards.

At block 314, the system 100 may apply a Large Language Model (LLM) may be used to automatically generate a comprehensive analysis report. The comprehensive analysis report may be based on the one or more anomalous products for product recall management and provides an in-depth analysis of key patterns and trends observed across different products or group of products. In an example, the comprehensive analysis report may summarize the findings, provide insights into why certain products were flagged, and present actionable information for decision-makers. In an example, the user may provide a structured prompt that ensures the generated report is detailed, accurate, and aligns with the specific use case. Based on the prompt, the LLM generates a structured comprehensive analysis report. In an example, the comprehensive analysis report may include a summary of the objective of the analysis. The objective may include the purpose of detecting anomalous batches and the importance of such detection in maintaining quality and compliance. In another example, the comprehensive analysis report may include explanation of the methods used in the analysis, including the machine learning algorithms and anomaly detection techniques applied. Further, the comprehensive analysis report may include description of the features or variables considered during the analysis, such as complaints, deviations and geographical distribution. The comprehensive analysis report may include a detailed list of the one or more anomalous products, highlighting key metrics associated with each of the one or more anomalous products. The comprehensive analysis report may include explanations for each product's anomaly status, including relevant data points that contributed to its classification. For example, the report might explain that product X was flagged due to a high number of complaints or severe process deviations.

In an example, the comprehensive analysis report may include insights into the severity of issues, geographical distribution, or any recurring patterns that might be influencing the anomalies. In an example, an explainability model like Shapley Additive exPlanations (SHAP) may be used, the comprehensive analysis report may include information on the feature contributions, showing how different variables (e.g., severity of complaints, number of deviations) influenced the detection of the anomaly. In another example, the comprehensive analysis report may include cross-products pattern analysis that describes common characteristics among the one or more anomalous products across the plurality of products. The cross-products pattern analysis may further describe notable differences between anomaly types and relationship between different metrics. In another example, the comprehensive analysis report may include detailed analysis of anomalous products with high risk assessment scores, common factors among high-risk products, and potential root causes for high-risk anomalies. In an example, risk assessment explanation is provided in which overall risk profile of the anomalous batches is explained. Further, potential implications for product lines and company reputation are provided in the comprehensive analysis report.

In another example, the comprehensive analysis report may include a section summarizing the key findings of the anomaly detection process. The section may further include actionable recommendations for stakeholders on how to address the anomalies, including potential corrective actions or further investigations.

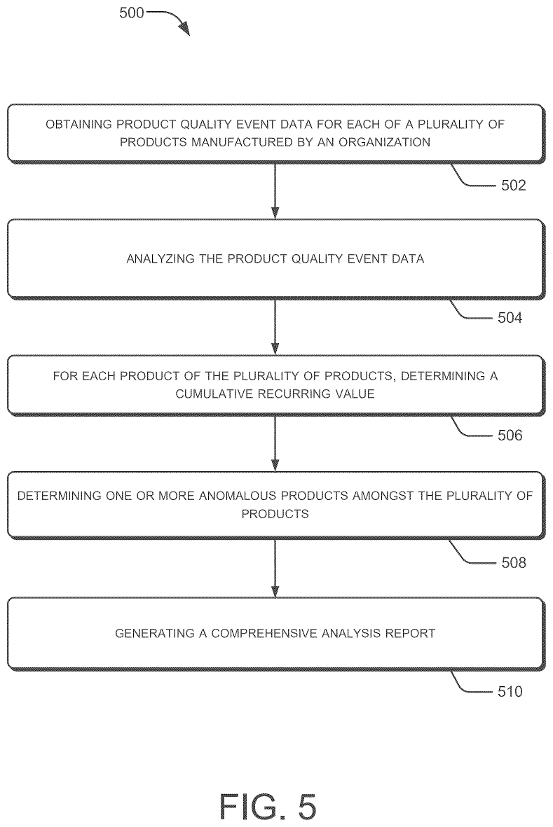

FIG. 5 illustrates a method 500 for product recall assessment, according to an example. At block 502, product quality event data corresponding to each of a plurality of products manufactured by an organization may be obtained. In an example, the product quality event data may be obtained from a quality management system implemented for managing and storing data related to quality concerns raised for products manufactured by the organization. In another example, the product quality event data may be pre-stored in a memory of the system 100 and may be obtained from the memory.

In an example, the corresponding product quality event data may include one or more quality events indicative of quality incident for each product of the plurality of products. In an example, the one or more one or more quality events indicative of quality incident for each product of the plurality of products may include complaints, deviations, non-conformances, and Corrective and Preventive Actions (CAPA) associated to respective products within the plurality of products. In one example, the product data may be stored as the product quality event data.

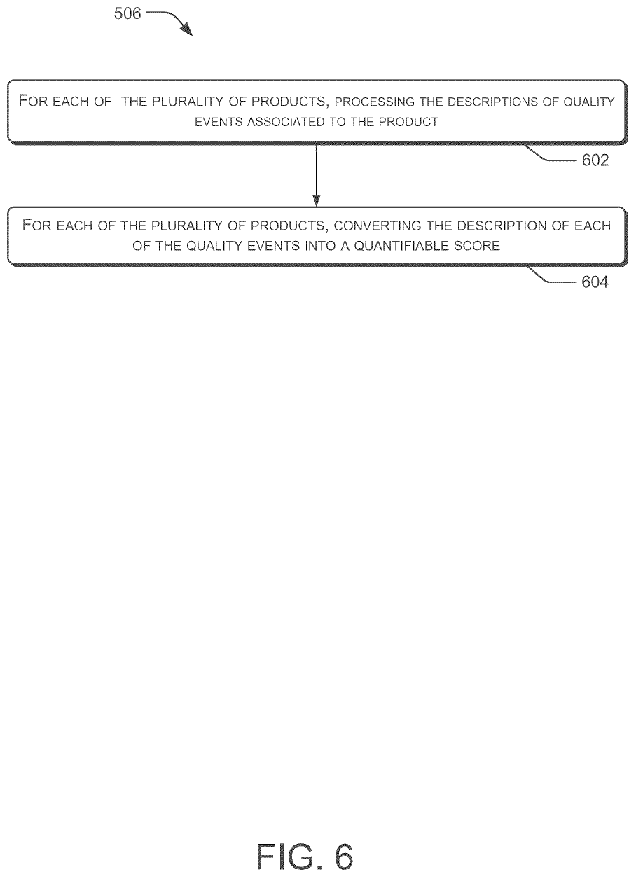

At block 504, the product quality event data is analyzed using a recurrent event model to obtain a recurring value of each quality event of the one or more quality events for each product of the plurality of products. For example, a recurring value of a product having a sudden increase in the number of complaints over a short period is obtained. The block 504 is further explained with reference to FIG. 6.

FIG. 6 illustrates the method for analyzing the product quality event data, according to an example. For analyzing the product quality event data, at block 602, the product quality event data is processed which may include the processing the descriptions of quality events, such as complaint descriptions, CAPA descriptions. The processing may further include cleaning the text description of the quality events. In an example, a text cleansing model which may be a natural language processing (NLP) model is employed for cleaning and preprocessing the product quality event data, making it suitable for analysis. In an example, the text cleansing model may transform the description of the quality event (such as complaint description) into usable information by removing punctuation and special characters, numbers, extra spaces.

At block 604, the description of the quality event is converted into a quantifiable score. For conversion, various techniques such as label encoding or pre-trained language model (like BERT, Word2Vec, or GloVe) to convert the complaint text into vector embeddings. The vector embeddings may capture the semantic meaning of the text. In an example, variable mapping may be applied for converting categorial variables into quantifiable measures. For example, complaint severity which can a categorial variable (e.g., low, medium, and high) is converted into quantifiable score.

Returning to FIG. 5, at block 506, for each product of the plurality of products, a cumulative recurring value based on the recurring value of each of the one or more quality events associated to the product is determined. The cumulative recurring value is indicative of all quality incidents associated with the product.

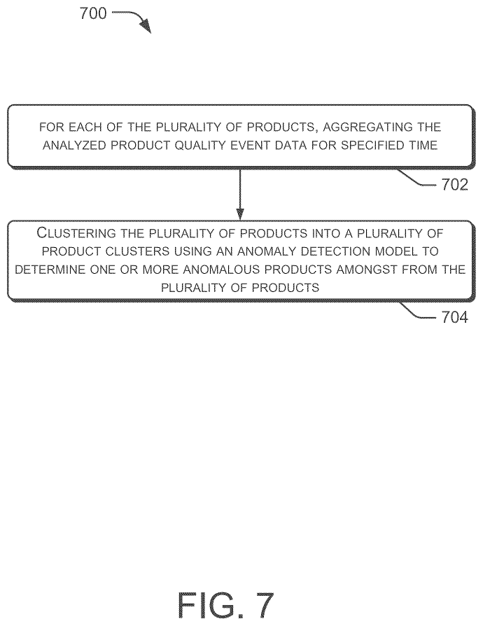

At block 508, one or more anomalous products amongst the plurality of products are determined. In an example, the one or more anomalous products amongst from the plurality of products is determined upon ascertaining deviation of the cumulative recurring value with a range of pre-determined threshold values. In an example, the pre-determined threshold values may be pre-stored in a memory of the system 100 and may be obtained from the memory. The block 508 is further explained with explained with reference to FIG. 7.

FIG. 7 illustrates a method 700 for determining the one or more anomalous products amongst the plurality of products, at block 508 of FIG. 5, according to another example.

At block 702, for each of the plurality of products, subsequent to obtaining the cumulative recurring value for each of the plurality of products, the analyzed product quality event data is aggregated for specified time. In an example, the specified time may be a week, a month, and a year. In an example, the aggregation may utilize aggregating operators such as summing function, mean function, count function etc. The summing function may total the numerical values across a group of products. For example, number of complaints received for each product over a month. The mean function may calculate the average value within a group of products. For example, determining an average complaint severity score for a particular group of products. The count function may count the number of occurrence within a group of products. For example, counting number of non-conformance events within a specific time period.

At block 704, the plurality of products may be clustered into a plurality of product clusters using an anomaly detection model. In an example, the anomaly detection model is a density-based clustering model. The anomaly detection model group similar data points together based on cumulative recurring value associated with the plurality of products. The anomaly detection model enables isolating products that deviate from the norm by detecting patterns of behaviour that differs from the majority. In an example, the norm is based on a range of pre-determined threshold values. As a result, one or more anomalous products amongst from the plurality of products are determined on ascertaining deviation of the cumulative recurring value with the range of pre-determined threshold values.

Returning to FIG. 5, at block 510, a comprehensive analysis report is generated based on the one or more anomalous products for product recall management. The comprehensive analysis report may provide an in-depth analysis of key patterns and trends observed across different products or group of products. In an example, the comprehensive analysis report may include a summary of the objective of the analysis. The objective may include the purpose of detecting anomalous batches and the importance of such detection in maintaining quality and compliance. In another example, the comprehensive analysis report may include a section summarizing the key findings of the anomaly detection process. The section may further include actionable recommendations for stakeholders on how to address the anomalies, including potential corrective actions or further investigations.

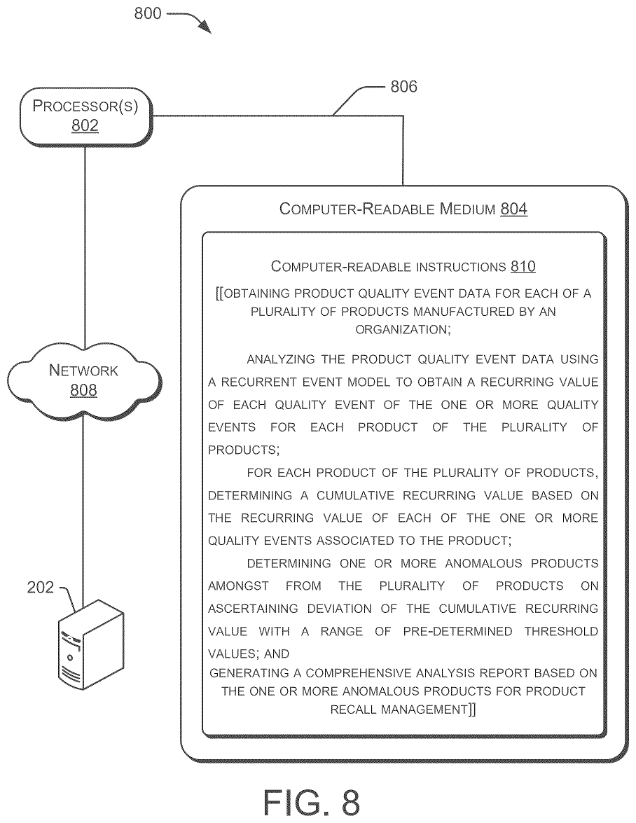

FIG. 8 illustrates a computing environment 800 implementing a non-transitory computer-readable medium for product recall management, according to an example. In an example, the computing environment 800 includes processor(s) 802 communicatively coupled to a non-transitory computer-readable medium 804 through a communication link 806. In one example, the communication link 806 may be similar to the communication network 806, as described in conjunction with the preceding figures. In an example implementation, the computing environment 800 may be for example, the computing environment 200. In an example, the processor(s) 802 may have one or more processing resources for fetching and executing computer-readable instructions from the non-transitory computer-readable medium 804. The processor(s) 802 and the non-transitory computer-readable medium 804 may be implemented, for example, in the system 100 (as has been described in conjunction with the preceding figures).

The non-transitory computer-readable medium 804 may be, for example, an internal memory device or an external memory device. In an example implementation, the communication link 806 may be a network communication link. The processor(s) 802 and the non-transitory computer-readable medium 804 may also be communicatively coupled to the data server 202 over a network 808. The network 808 may be similar to the communication network 206 described in conjunction with FIG. 2.

In an example implementation, the non-transitory computer-readable medium 804 may include a set of computer-readable instructions 810 which may be accessed by the processor(s) 802 through the communication link 806. Referring to FIG. 8, in an example, for a plurality of products manufactured by an organization, the non-transitory computer-readable medium 804 may include instructions 810 that may cause the processor(s) 802 to obtain product quality event data for each of the plurality of products manufactured by the organization. In an example, the product quality event data may include one or more quality events indicative of quality incident for each product of the plurality of products. Examples of quality event may include, but are not limited to, a complaint received against a faulty product, a deviation associated with a faulty product, a corrective and preventive action (CAPA) taken for a faulty product, and a non-conformance assessment of a faulty product.

Upon obtaining the product quality event data, the non-transitory computer-readable medium 804 may include instructions 810 that may cause the processor(s) 802 to analyze the product quality event data using a recurrent event model to obtain a recurring value of each quality event of the one or more quality events for each product of the plurality of products. For example, number of complaints associated with a product X among the plurality of products observes a sudden increase in a week period of time. The recurrent event model may count the number of complaints and assign a recurring value to the product X. Further, for each product of the plurality of products, a cumulative recurring value based on the recurring value of each of the one or more quality events associated with the product is obtained. The cumulative recurring value is indicative of all quality incidents associated with the product. In an example, the cumulative recurring value may be a recurrent complaint count indicating a similar complaint reported within a prespecified time. In another example, the cumulative recurring value may be a ratio indicating the percentage of recurrent complaints relative to total complaints for a given product or a group of products. In another example, the cumulative recurring value may include a time-series feature tracking the trend of recurrent complaints over time. For example, an increasing time-series trend of recurrent complaints over time. Thus, if multiple customers repeatedly complain about the same issue, such as poor quality of the product, these complaints can be quantified and analyzed to understand the frequency and severity of the problem. In an example, the analyzed product quality event data is aggregated from a specified time (e.g., week, month, half-year, year).

The non-transitory computer-readable medium 804 may include instructions 810 that may cause the processor(s) 802 to determining one or more anomalous products amongst from the plurality of products on ascertaining deviation of the cumulative recurring value with a range of pre-determined threshold values. In an example, the pre-determined threshold values may be pre-stored in a memory of the system 100 and may be obtained from the memory. In an example, unsupervised machine learning technique, such as, clustering technique may be applied to determine the one or more anomalous products. In an example, the clustering technique may be a density-based clustering technique. The non-transitory computer-readable medium 804 may include instructions 810 that may cause the processor(s) 802 to determine one or more anomalous products amongst the plurality of products that deviate from the norm based on pattern that differs from the majority of the products amongst the plurality of products.

The instructions 810 may further cause the processor(s) 802, in one example, to generating a comprehensive analysis report based on the one or more anomalous products for product recall management. The comprehensive analysis report may be based on the one or more anomalous products for product recall management and provides an in-depth analysis of key patterns and trends observed across different products or group of products. In an example, the comprehensive analysis report may summarize the findings, provide insights into why certain products were flagged, and present actionable information for decision-makers. In an example, the comprehensive analysis report may include a summary of the objective of the analysis. The objective may include the purpose of detecting anomalous batches and the importance of such detection in maintaining quality and compliance. In another example, the comprehensive analysis report may include explanation of the methods used in the analysis, including the machine learning algorithms and anomaly detection techniques applied. Further, the comprehensive analysis report may include description of the features or variables considered during the analysis, such as complaints, deviations and geographical distribution. The comprehensive analysis report may include a detailed list of the one or more anomalous products, highlighting key metrics associated with each of the one or more anomalous products. The comprehensive analysis report may include explanations for each product's anomaly status, including relevant data points that contributed to its classification. For example, the report might explain that product X was flagged due to a high number of complaints or severe process deviations. In an example, the comprehensive analysis report may include insights into the severity of issues, geographical distribution, or any recurring patterns that might be influencing the anomalies. In an example, an explainability model like Shapley Additive explanations (SHAP) may be used, the comprehensive analysis report may include information on the feature contributions, showing how different variables (e.g., severity of complaints, number of deviations) influenced the detection of the anomaly. In another example, the comprehensive analysis report may include cross-products pattern analysis that may describe common characteristics among the one or more anomalous products across the plurality of products, notable differences between one or more anomalous products. In another example, the comprehensive analysis report may include detailed analysis of anomalous products with high risk assessment scores and potential root causes for high-risk anomalies. In another example, the comprehensive analysis report may include a section summarizing the key findings of the anomaly detection process. The section may further include actionable recommendations for stakeholders on how to address the anomalies, including potential corrective actions or further investigations.

The present subject matter therefore leverages machine learning techniques to recognize evolving patterns and adjusting its criteria accordingly. This adaptive capability may allow the system 100 to maintain its effectiveness over time as product characteristics and quality patterns change. The Al-driven approach may complement existing quality management processes, potentially providing additional insights to support decision-making regarding product investigations or recall considerations. The system may contribute to ongoing efforts to maintain product quality and respond efficiently to potential quality concerns. The present subject matter generates customized assessment reports that provide the manufacturers with actionable insights specific to their target product, facilitating informed decision-making and enabling timely implementation of strategies for mitigating the quality concerns. By offering a proactive and data-driven method for product management, the present subject matter enables the manufactures to maintain product quality, protect consumers from safety risks, and safeguard their reputation in the market. The sequential implementation of diverse analytical techniques allows for a nuanced and thorough examination of the quality event data. Ultimately, the present invention addresses a critical gap in current product quality assessment practices, potentially leading to significant cost savings and enhanced consumer trust.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A method comprising:
obtaining product quality event data for each of a plurality of products manufactured by an organization, wherein the product quality event data includes one or more quality events indicative of a quality incident for each product of the plurality of products;
analyzing the product quality event data using a recurrent event model to obtain a recurring value of each quality event of the one or more quality events for each product of the plurality of products;
for each product of the plurality of products, determining a cumulative recurring value based on the recurring value of each of the one or more quality events associated with the product, wherein the cumulative recurring value is indicative of all quality incidents associated with the product;
determining one or more anomalous products from the plurality of products on ascertaining deviation of the cumulative recurring value with a range of pre-determined threshold values, wherein criteria for determining the one or more anomalous products are adjusted, based on the product quality event data obtained over time, as quality patterns change, and wherein the deviation is ascertained by clustering the plurality of products into a plurality of product clusters using a density-based clustering model that groups products according to the cumulative recurring value, and flagging as an anomalous product a product whose cumulative recurring value is located beyond a threshold distance from a centroid of the product cluster to which the product is assigned or within a sparse region of a data space defined by the plurality of product clusters; and
generating a comprehensive analysis report based on the one or more anomalous products for product recall management, wherein the comprehensive analysis report includes recommendations for taking corrective actions for the one or more anomalous products.

2. The method as claimed in claim 1, further comprising:
obtaining one or more high-dimensional vectors representing semantic and syntactic characteristics of the product quality event data; and
parsing the one or more high-dimensional vectors through a vector space of a vector embedding model for searching vector embeddings in the vector space close to a high-dimensional vector of the one or more high-dimensional vectors.

3. The method as claimed in claim 1, wherein the cumulative recurring value includes at least one of:
a recurrent complaint count indicating recurring complaints corresponding to the product, reported within a specified time;
a recurrent complaint ratio indicating a ratio of recurrent complaints relative to total complaints corresponding to the product; and
a recurrent complaint pattern indicating a trend of recurrent complaints corresponding to the product over a specified time.

4. The method as claimed in claim 1, further comprising:
aggregating the product quality event data using at least one aggregating operator for a specified time, wherein the at least one aggregating operator is a statistical function.

5. The method as claimed in claim 1, wherein the comprehensive analysis report includes cross-products pattern analysis, wherein the cross-products pattern analysis includes at least determination of common characteristics among the one or more anomalous products across the plurality of products.

6. (canceled)

7. The method as claimed in claim 1, wherein the comprehensive analysis report is generated using a Large Language Model (LLM), the method further comprising: determining, using an explainability model, feature contributions quantifying an extent to which each of a plurality of variables of the product quality event data influenced determination of each of the one or more anomalous products; and wherein generating the comprehensive analysis report comprises providing the feature contributions in a structured prompt to the LLM, wherein the comprehensive analysis report includes the feature contributions.

8. A system comprising:
processor;
a memory storing program instructions which, when executed by the processor, cause the processor to:
obtain product quality event data for each of a plurality of products manufactured by an organization, wherein the product quality event data includes one or more quality events indicative of a quality incident for each product of the plurality of products;
analyze the product quality event data using a recurrent event model to obtain a recurring value of each quality event of the one or more quality events for each product of the plurality of products;
for each product of the plurality of products, determine a cumulative recurring value based on the recurring value of each of the one or more quality events associated with the product, wherein the cumulative recurring value is indicative of all quality incidents associated with the product;
determine one or more anomalous products from the plurality of products on ascertaining deviation of the cumulative recurring value with a range of pre-determined threshold values, wherein criteria for determining the one or more anomalous products are adjusted, based on the product quality event data obtained over time, as quality patterns change, and wherein the deviation is ascertained by clustering the plurality of products into a plurality of product clusters using a density-based clustering model that groups products according to the cumulative recurring value, and flagging as an anomalous product a product whose cumulative recurring value is located beyond a threshold distance from a centroid of the product cluster to which the product is assigned or within a sparse region of a data space defined by the plurality of product clusters; and
generate a comprehensive analysis report based on the one or more anomalous products for product recall management, wherein the comprehensive analysis report includes recommendations for taking corrective actions for the one or more anomalous products.

9. The system as claimed in claim 8, wherein the processor is further configured to:
obtain one or more high-dimensional vectors representing semantic and syntactic characteristics of the product quality event data; and
parse the one or more high-dimensional vectors through a vector space of a vector embedding model for searching vector embeddings in the vector space close to a high-dimensional vector of the one or more high-dimensional vectors.

10. The system as claimed in claim 8, wherein the cumulative recurring value includes at least one of:
a recurrent complaint count indicating recurring complaints corresponding to the product, reported within a specified time;
a recurrent complaint ratio indicating a ratio of recurrent complaints relative to total complaints corresponding to the product; and
a recurrent complaint pattern indicating a trend of recurrent complaints corresponding to the product over a specified time.

11. The system as claimed in claim 8, wherein the processor is further configured to:
aggregate the product quality event data using at least one aggregating operator for a specified time, wherein the at least one aggregating operator is a statistical function.

12. The system as claimed in claim 8, wherein the comprehensive analysis report includes cross-products pattern analysis, wherein the cross-products pattern analysis includes at least determination of common characteristics among the one or more anomalous products across the plurality of products.

13. (canceled)

14. The system as claimed in claim 8, wherein the comprehensive analysis report is generated, by the processor, using a Large Language Model (LLM), wherein the processor is further configured to: determine, using an explainability model, feature contributions quantifying an extent to which each of a plurality of variables of the product quality event data influenced determination of each of the one or more anomalous products; and wherein the comprehensive analysis report is generated by providing the feature contributions in a structured prompt to the LLM, wherein the comprehensive analysis report includes the feature contributions.

15. A non-transitory computer-readable medium having instructions stored thereon, the instructions, when executed by a processor, cause the processor to perform operations comprising:
obtaining product quality event data for each of a plurality of products manufactured by an organization, wherein the product quality event data includes one or more quality events indicative of a quality incident for each product of the plurality of products;
analyzing the product quality event data using a recurrent event model to obtain a recurring value of each quality event of the one or more quality events for each product of the plurality of products;
for each product of the plurality of products, determining a cumulative recurring value based on the recurring value of each of the one or more quality events associated with the product, wherein the cumulative recurring value is indicative of all quality incidents associated with the product;
determining one or more anomalous products from the plurality of products on ascertaining deviation of the cumulative recurring value with a range of pre-determined threshold values, wherein criteria for determining the one or more anomalous products are adjusted, based on the product quality event data obtained over time, as quality patterns change, and wherein the deviation is ascertained by clustering the plurality of products into a plurality of product clusters using a density-based clustering model that groups products according to the cumulative recurring value, and flagging as an anomalous product a product whose cumulative recurring value is located beyond a threshold distance from a centroid of the product cluster to which the product is assigned or within a sparse region of a data space defined by the plurality of product clusters; and
generating a comprehensive analysis report based on the one or more anomalous products for product recall management, wherein the comprehensive analysis report includes recommendations for taking corrective actions for the one or more anomalous products.

16. The non-transitory computer-readable medium as claimed in claim 15, wherein the instructions, when executed by a processor, cause the processor to perform operations further comprising:
obtaining one or more high-dimensional vectors representing semantic and syntactic characteristics of the product quality event data; and
parsing the one or more high-dimensional vectors through a vector space of a vector embedding model for searching vector embeddings in the vector space close to a high-dimensional vector of the one or more high-dimensional vectors.

17. The non-transitory computer-readable medium as claimed in claim 15, wherein the cumulative recurring value includes at least one of:
a recurrent complaint count indicating recurring complaints corresponding to the product, reported within a specified time;
a recurrent complaint ratio indicating a ratio of recurrent complaints relative to total complaints corresponding to the product; and
a recurrent complaint pattern indicating a trend of recurrent complaints corresponding to the product over a specified time.

18. The non-transitory computer-readable medium as claimed in claim 15, wherein the instructions, when executed by a processor, cause the processor to perform operations further comprising:
aggregating the product quality event data using at least one aggregating operator for a specified time, wherein the at least one aggregating operator is a statistical function.

19. The non-transitory computer-readable medium as claimed in claim 15, wherein the comprehensive analysis report includes cross-products pattern analysis, wherein the cross-products pattern analysis includes at least determination of common characteristics among the one or more anomalous products across the plurality of products.

20. (canceled)

21. The method as claimed in claim 1, wherein the one or more quality events include free-text descriptions, the method further comprising:
processing the free-text descriptions using a natural language processing text cleansing model to obtain cleansed descriptions;
converting the cleansed descriptions into one or more high-dimensional vectors representing semantic and syntactic characteristics using a vector embedding model; and
converting a categorical severity of each quality event into a quantifiable severity score, wherein the recurring value is obtained from the quantifiable severity score.

22. The method as claimed in claim 1, wherein the recurring value denotes a number of times the same quality event has reoccurred for the product within a prespecified time, and the cumulative recurring value comprises a recurrent complaint ratio of recurrent complaints relative to total complaints corresponding to the product and a time-series recurrent complaint pattern tracking a trend of the recurrent complaints for the product over time, wherein the clustering of the plurality of products is performed using the recurrent complaint ratio and the time-series recurrent complaint pattern.

23. The method as claimed in claim 1, further comprising: receiving a user selection of a feature name from a list of feature names associated with the plurality of products and a user selection of an aggregating operator from a list of aggregating operators, each aggregating operator being a statistical function; aggregating the recurring value and the cumulative recurring value of each of the plurality of products according to the selected feature name and the selected aggregating operator at a plurality of aggregation levels including a geographical location level and at least two different time levels; and clustering the plurality of products using the aggregated cumulative recurring value of each of the plurality of products.
